(19) United States
(12) Patent Application Publication
(10) Pub. No.: US 2011/0020548 A1
(43) Pub. Date: Jan. 27, 2011

(54) DEVICE AND METHOD FOR THE PARTIAL COATING OF COMPONENTS

(75) Inventors: Wolfgang Eichmann, Puchheim (DE); Falko Heutling, Muenchen (DE); Thomas Uihlein, Dachau (DE); Josef Lachner, Jetzendorf Kemmoden (DE)

Correspondence Address: CROWELL & MORING LLP;INTELLECTUAL PROPERTY GROUP, P.O. BOX 14300, WASHINGTON, DC, 20044-4300, US

(73) Assignee: MTU AERO ENGINES GMBH, Munich (DE)

(21) Appl. No.: 12/867,672

(22) PCT Filed: Feb. 4, 2009
(86) PCT No.: PCT/DE2009/000153

§ 371 Date: Aug. 13, 2010

(30) Foreign Application Priority Data
Feb. 14, 2008 (DE) 10 2008 011 242.9

(51) Int. Cl. B05D 1/32; B05C 9/00

(52) U.S. Cl. 427/282; 118/504

(57) ABSTRACT

A device and method for the partial coating of a component, particularly for the coating of components of a gas turbine or an aircraft engine, is disclosed. The device includes at least one base receptacle for at least partially receiving the component and a first partial region of the component not to be coated. The device further includes at least one plate-shaped cover that can be positioned in the base receptacle, where the cover includes at least one recess or opening for a second partial region of the component to be coated to pass through. The shape of the recess or opening corresponds to the profile of the component in the region between the partial region not to be coated and the partial region to be coated.

This application claims the priority of International Application No. PCT/DE2009/000153, filed Feb. 4, 2009, and German Patent Document No. 10 2008 011 242.9, filed Feb. 14, 2008, the disclosures of which are expressly incorporated by reference herein.

### BACKGROUND AND SUMMARY OF THE INVENTION

The present invention relates to a device for the partial coating of a component, particularly for the coating of components of a gas turbine or an aircraft engine. The invention further relates to a method for the partial coating of a component, particularly for the coating of components of a gas turbine or an aircraft engine.

Components, in particular components of a gas turbine or an aircraft engine, which are subject to erosive stress, are generally coated with layers, in particular erosion-resistant layers. However, these protective layers may have a negative impact on the fatigue strength and/or service life of these types of components. This applies particularly in the case of ceramic hard material layers, which serve in particular to protect against erosion, because there is a risk that incipient cracks in the ceramic layer will rapidly run into the base material of the component and lead to premature failure of the component. In particular these incipient cracks occur in layer regions subject to high component stress, such as for example, those with high tensile strain. The possibility that such incipient cracks will form in coated component regions subject to high stress, particularly high mechanical stress, therefore has a negative impact on the quality and the service life of the corresponding component in this region.

It is therefore the object of the present invention to make available a generic device for the partial coating of a component, particularly for the coating of components of a gas turbine or an aircraft engine, which makes a reliable and quick coating of the component possible while taking critical component regions into account, i.e., regions that are subject to high component stress, in particular mechanical stress.

It is further the object of the present invention to make available a generic method for the partial coating of a component, particularly for the coating of components of a gas turbine or an aircraft engine, which makes a reliable and quick coating of the component possible while taking critical component regions into account, i.e., regions that are subject to high component stress, in particular mechanical stress.

A device according to the invention for the partial coating of a component, particularly for the coating of components of a gas turbine or an aircraft engine comprises at least one base receptacle for at least partially receiving the component and a first partial region of the component not to be coated, and at least one plate-shaped cover that can be positioned in the base receptacle, and wherein the cover comprises at least one recess or opening for a second partial region of the component to be coated to pass through and the shape of the recess or opening corresponds to the profile of the component in the region between the partial region not to be coated and the partial region to be coated. The device according to the invention makes it possible for critical component regions, i.e., regions subject to high component stress, particularly high mechanical stress, to be masked or covered so that these regions are not coated. As a result, the development of incipient cracks from a coating in the base material of the component which could lead to a premature failure of the component as a whole is avoided in these critical partial regions of the component. The partial regions of the component that are not covered or masked may be coated reliably and quickly. In designing the plate-like cover and the corresponding recess or opening for the partial region to be coated to pass through, knowledge about the stress pattern of the component, particularly a mechanical stress pattern, is taken into account so that there may be an optimized distribution between the coated and non-coated partial regions of the component.

In advantageous embodiments of the device according to the invention, the cover is configured to be flat, uneven or arched, or straight, curved or polygonal in cross section. Other embodiments of the cover are also conceivable, wherein the design of the cover is always based on an optimized separation between the partial regions of the component to be coated and those not to be coated with knowledge of the component stress. In addition, it is possible for the cover to be made of metal, a metal alloy, ceramic, glass or plastic, in particular temperature-resistant plastic.

In a further advantageous embodiment of the device according to the invention, the base receptacle has corresponding support regions or projections for positioning, in particular for positioning the height of the cover. This makes it possible for the base receptacle to be adapted to the separation required in the respective individual case of the partial regions of the component to be coated and those not to be coated.

In another advantageous embodiment of the device according to the invention, the base receptacle is configured to be displaceable for changing the position of the cover in relation to the component. This makes it possible to make a change in the position of the cover relative to the component to be coated, for example during the coating process. As a result, it is possible in an advantageous manner to vary the layer thickness of the coating. In addition, it is possible, particularly in the case of multiple layers, to apply different multilayers on the component.

In another advantageous embodiment of the device according to the invention, the device has at least one fixing device for detachably fixing the cover on the base body. In this case, the fixing device may be configured to be sleeve-like with at least one passage opening for the second partial region of the component to be coated to pass through.

In a further advantageous embodiment of the device according to the invention, the partial coating of the component is carried out by means of a physical vapor deposition method (PVD).

In another advantageous embodiment of the invention, the coating is a protective layer, in particular an erosion-resistant layer. In this case, the protective layer may be made in particular of a hard ceramic material and/or a metal or a metal alloy. Titanium nitride for example may be used as the hard ceramic material. The protective layer in this case may be made of several layers, wherein for example, a layer is structured in an alternating manner of a hard ceramic material and a metal or a metal alloy.

In further advantageous embodiments of the device according to the invention, the component is a blade of a rotor of a gas turbine, wherein the blade may be in particular part of an integral rotor design (BLISK or BLING). A method according to the invention for the partial coating of a component, particularly for the coating of components of a gas turbine or an aircraft engine, is comprised of the following steps:

a) Receiving and positioning the component in a base receptacle;

b) Covering a partial region of the component not to be coated by means of a cover, wherein a partial region of the component to be coated is fed through a recess or opening in the cover and the shape of the recess or opening corresponds to the profile of the component in the region between the partial region not to be coated and the partial region to be coated; and

c) Coating the partial region of the component to be coated.

It is advantageously possible through the method according to the invention for critical component regions, i.e., regions subject to high component stress, in particular mechanical stress, to be masked or covered so that there is no coating in these partial regions of the component. As a result, a formation of cracks initiated by the coating, which may extend into the region of the base material of the component, is prevented. In addition, a reliable and rapid coating of those partial regions of the component that lie outside of the cited critical component regions is possible. The design of the cover in this case takes into account the distribution of the component stress, wherein the partial regions that are subject to high component stress are reliably masked by the cover. In an advantageous embodiment of the method according to the invention, prior to the process step c), a fixing of the base receptacle with the cover is carried out by means of a fixing device. In addition, it is possible for the fixing device to be configured to be sleeve-like with at least one passage opening for the second partial region of the component to be coated to pass through. These process steps guarantee a secure positioning of the cover in the base receptacle as well as a secure fastening of the to-be-coated component in the base receptacle.

In another advantageous embodiment of the method according to the invention, the base receptacle is configured to be displaceable for changing the position of the cover in relation to the component, wherein a change in the position of the cover is made after and/or during the coating according to process step c). Because of the possibility of changing the position of the cover in relation to the component it is possible for different layer thicknesses to be applied to the component. In addition, it is possible, for example in the case of multilayered coatings, for the layer regions to be applied on the component in a different layer sequence. Furthermore, this makes a coating with a homogeneous layer run-out possible.

In a further advantageous embodiment of the method according to the invention, the partial coating of the component is carried out by means of a physical vapor deposition method (PVD).

In another advantageous embodiment of the method according to the invention, a protective layer, in particular an erosion-resistant layer, is formed by the coating according to process step c). The protective layer in this case may be made of a hard ceramic material such as for example, TiN and/or a metal or a metal alloy. The protective layer may also be configured to be multilayered, wherein for example, hard ceramic materials and metallic materials are formed in an alternating manner.

A device or a method as described in the foregoing is used in particular for producing and repairing engine components, particularly for producing, repairing and coating integral rotor designs (BLISK or BLING).

A component of a gas turbine or an aircraft engine according to the invention is produced in accordance with a method according to the invention described in the foregoing and/or by means of a device according to the invention described in the foregoing. In this case, the component may be a blade of a rotor of a gas turbine or a blade as part of an integral rotor design (BLISK or BLING).

Additional advantages, features and details of the invention are disclosed in the following description of two graphically depicted exemplary embodiments.

### BRIEF DESCRIPTION OF THE DRAWINGS

FIG. 1 is a schematic representation of a component to be partially coated;

FIG. 2 is a schematic representation of a device according to the invention for the partial coating of a component in accordance with a first embodiment; and

FIG. 3 is a schematic representation of a device according to the invention in accordance with a second embodiment.

### DETAILED DESCRIPTION OF THE DRAWINGS

FIG. 1 shows a schematic representation of a component 12 to be partially coated. The component 12 is a blade of a rotor of a gas turbine made of a blade pan 32 and a blade root 34. FIG. 1 also schematically depicts a first partial region 20 not to be coated and a second partial region 22 of the component 12 or of the blade that is to be coated. High mechanical component stress in particular develops in the region of the first partial region 20.

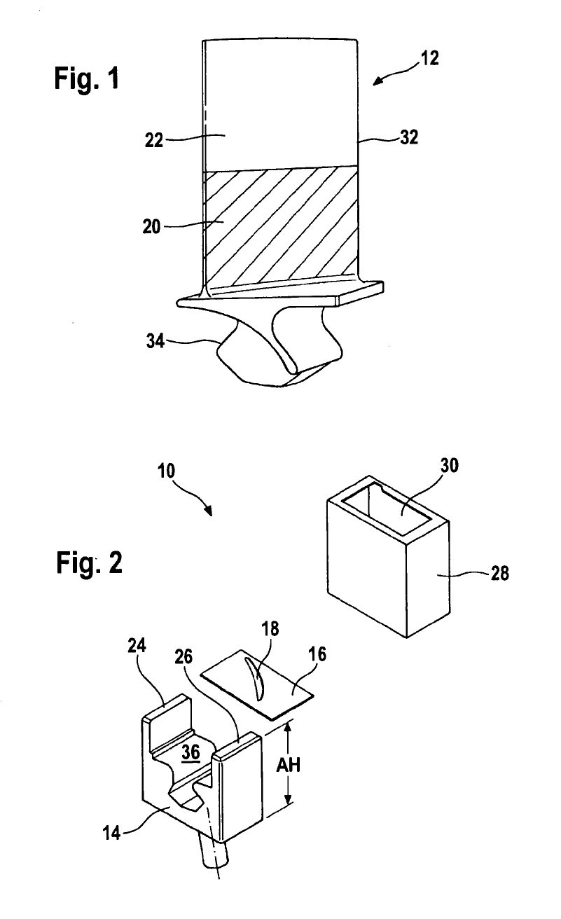

FIG. 2 shows a schematic representation of a device 10 for the partial coating of the component 12 depicted in FIG. 1. The device 10 here includes a base receptacle 14 for partially receiving the component 12, in particular the blade root 34 of the first partial region 20 of the blade pan 32. The base receptacle 14 has a recess 36 adapted in terms of its shape to these regions of the component 12. In addition, the device 10 has a plate-shaped cover 16, wherein the cover 16 has an opening 18 for the second partial region 22 of the component 12 to be coated to pass through. One can see that the shape of the opening 18 corresponds to the profile of the component 12 in the region between the partial region not to be coated and the partial region to be coated 20, 22 (also see FIG. 1). In the depicted exemplary embodiment, the cover 16 is configured to be flat and straight in cross section. However, other designs of the cover 16 are possible corresponding to the progression of the border area between second partial region 22 to be coated and the first partial region 20 not to be coated. Furthermore, the base receptacle 14 has two opposing support regions 24, 26 for positioning and particularly for positioning the height of the cover 16. The support height AH in this case is defined by the arrangement of the support regions 24, 26 in or on the base receptacle 14. The device 10 depicted in the exemplary embodiment also has a fixing device 28 for detachably fixing the cover 16 to the base body 14. Here the fixing device 28 is configured to be sleeve-like and is put over the base receptacle 14. The fixing device 28 has a passage opening 30 for the second partial region 22 of the component 12 to be coated to pass through.

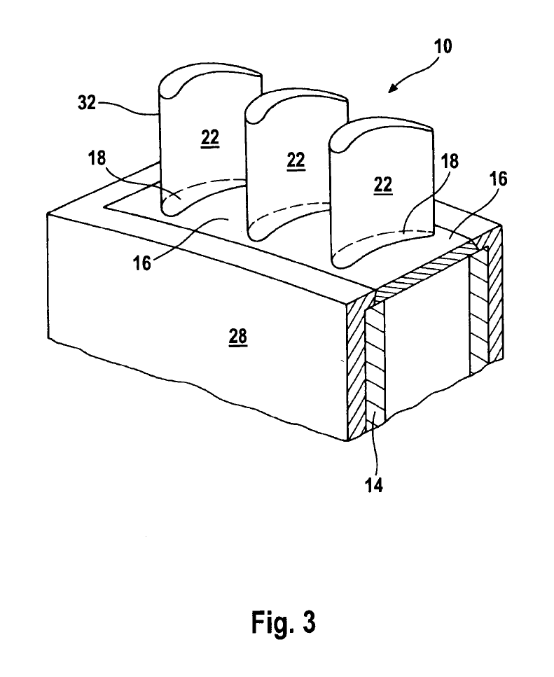

FIG. 3 shows a schematic representation of a device 10 according to a second embodiment. The device 10 in this case is depicted as a partial section. One can see that the base receptacle 14 and the cover 16 are surrounded by the fixing device 28 that is configured to be sleeve-like. The cover 16 in this exemplary embodiment has a total of three openings 18 for the corresponding second partial regions 22 of a component 12 to be coated to pass through. The partial regions 22 are again partial regions of blades of a rotor of a gas turbine. In particular, they are partial regions of the blade pans 32. One can see that the openings 18 in turn have a shape, which corresponds to the profile of the blade pan 32 in the region between the partial region not to be coated and the partial region to be coated 20, 22.

1-23. (canceled)

24. A device for partial coating of components of a gas turbine or an aircraft engine, comprising:
a base receptacle for at least partially receiving a component and a first region of the component that is not to be coated; and
a plate-shaped cover that is positionable in the base receptacle, wherein the cover includes a recess or opening through which a second region of the component that is to be coated is passable;
wherein the component is a blade pan and wherein a shape of the recess or opening corresponds to a profile of the blade pan in a region between the first region and the second region.

25. The device according to claim 24, wherein the cover is configured to be one-piece or multipart and flat, uneven, arched, straight, curved or polygonal in cross-section.

26. The device according to claim 24, wherein the cover is made of a metal, a metal alloy, a ceramic, a glass, or a plastic.

27. The device according to claim 24, wherein the base receptacle includes support regions or projections for positioning a height of the cover.

28. The device according to claim 24, wherein the device includes a fixing device for detachably fixing the cover on the base receptacle.

29. The device according to claim 28, wherein the fixing device is configured to be sleeve-like with a passage opening through which the second region of the component is passable.

30. The device according to claim 24 in combination with a coating for coating the second region, wherein the coating is a protective layer.

31. The device according to claim 30, wherein the coating is made of a hard ceramic material and/or a metal or a metal alloy.

32. The device according to claim 24, wherein the blade pan is a blade pan of a blade of a rotor of a gas turbine.

33. The device according to claim 32, wherein the blade is part of an integral rotor design.

34. A method for partial coating of a component of a gas turbine or an aircraft engine, comprising the steps of:
a) receiving and positioning a component in a base receptacle;
b) covering a first region of the component that is not to be coated by a cover and feeding a second region of the component that is to be coated through a recess or opening in the cover; and
c) coating the first region of the component;
wherein the component is a blade pan and wherein a shape of the recess or opening corresponds to a profile of the blade pan in a region between the first region and the second region.

35. The method according to claim 34, wherein prior to step c), the base receptacle is fixed with the cover by a fixing device.

36. The method according to claim 35, wherein the fixing device is configured to be sleeve-like with a passage opening and wherein the second region of the component is fed through the passage opening.

37. The method according to claim 34, wherein a protective layer is formed by the coating of step c).

38. The method according to claim 37, wherein the protective layer is made of a hard ceramic material and/or a metal or a metal alloy.
